(19) United States
(12) Patent Application Publication
(10) Pub. No.: US 2008/0266041 A1
(43) Pub. Date: Oct. 30, 2008

(54) HIGH CURRENT LOW-PROFILE CURRENT CHOKES SUITABLE FOR USE IN DC TO DC CONVERTERS

(75) Inventors: Yongxue He, Chattanooga, TN (US); Aaron Fitzsimmons, Hixon, TN (US)

Correspondence Address: HARNESS, DICKEY, & PIERCE, P.L.C, 7700 Bonhomme, Suite 400, ST. LOUIS, MO, 63105, US

(73) Assignee: Laird Technologies, Inc., St. Louis, MO (US)

(21) Appl. No.: 11/742,509

(22) Filed: Apr. 30, 2007

(51) Int. Cl. H01F 17/04

(52) U.S. Cl. 336/155

(57) ABSTRACT

According to various aspects, exemplary embodiments are provided of current chokes suitable for use in DC to DC converters. For example, a current choke may include a ferrite body with at least one pair of laterally spaced-apart interior conductors disposed lengthwise within the body. A first pair of end terminations may be disposed on a first end of the body and connected to the interior conductors, and a second pair of end terminations may be disposed on a second end of the body and connected to the interior conductors. A nonmagnetic dielectric may be disposed within the body laterally between the interior conductors. The nonmagnetic dielectric may be configured to control magnetic coupling between the at least one pair of interior conductors so that the current choke is operable with a coefficient of magnetic coupling between the interior conductors of less than about 0.90.

### FIELD

The present disclosure relates generally to the field of electronic devices, and, more particularly to ferrite inductive components, such as current chokes that may be surface mounted to circuit boards and/or that are suitable for use with DC to DC converters.

### BACKGROUND

The statements in this section merely provide background information related to the present disclosure and may not constitute prior art.

Generally, a DC to DC converter is a circuit operable for converting a source of direct current from one voltage to another. Many battery-powered portable electronic devices, such as cellular phones and laptop computers, have DC to DC converters for converting the voltage level supplied by a single battery to different voltage levels required for operating different sub-circuits of the electronic device. Accordingly, DC to DC converters can allow for generation of multiple controlled voltages from a single battery voltage, which, in turn, may thus save space by eliminating the need for multiple batteries to supply different voltages to different electronic parts of the electronic device.

One type of DC to DC converter is referred to as an electronic switch-mode DC to DC converter, which may be used for converting one DC voltage level to another. In an exemplary operation, the DC to DC converter performs the conversion by applying a DC voltage across an inductor or transformer for a period of time. This, in turn, causes current to flow through the DC to DC converter with energy being stored magnetically. The voltage may then be switched off, at which point the stored energy transfers to the voltage output in a controlled manner. The output voltage may be regulated even when the current demand changes by adjusting the ratio of on/off time.

Another type of DC to DC converter is referred to as a current-output DC to DC converter. In an exemplary operation, a current-output DC to DC converter accepts a DC power input and outputs a constant current. The output voltage from the DC to DC converter may depend on the impedance of the load.

Chokes are another device commonly used with electronic devices, but for a different purpose (e.g., filtering unwanted signals) than that of DC to DC converters. Generally, a choke is an inductor configured to have a high reactance to a particular frequency when used in a signal-carrying circuit. In operation, chokes may block signal frequencies above a desired range, while at the same time allowing DC or low frequency signals to pass. Thus, chokes have been employed to prevent or inhibit electromagnetic interference (EMI) from disturbing various electronic devices. There are also other applications where a choke may be needed to filter unwanted signals.

A choke is typically provided by a magnetic core through which, or around which, conductors or windings are positioned. Thus, a typical choke defines first and second mutually coupled magnetic paths. For any choke to function as intended, its inductance or inductive reactance, should not fall below a specific minimum, even though the current in a winding rises to a maximum value. Beyond the maximum current value, the reactance falls off significantly. The choke's ability to impede interference signals drops, thereby allowing the passage of unwanted signals. It is therefore typically desirable to prevent or inhibit a choke from being driven into such a saturation condition.

Ferrite materials are commonly used as the core material for many chokes because, for example, ferrites have sensitive magnetic-frequency relationships. The ferrite material used to form the choke will determine which signal frequencies the choke will attenuate. Most ferrites having suitable inductance values for choke applications saturate at about 4,000 Gauss. Accordingly, when configured differentially, ferrites have a relatively low current carrying capacity before the choke is driven into saturation and its impedance level deteriorates at the desired filter frequency. To prevent or inhibit this saturation, chokes may include a core air gap, use a larger cross-section core, or simply to limit the allowable current.

### SUMMARY

According to various aspects, exemplary embodiments of current chokes for use in DC to DC converters are provided. In one exemplary embodiment, a current choke is suitable for surface mounting to a circuit board for use in a DC to DC converter. The current choke generally comprises a generally rectangular body having opposing first and second ends, a lower ferrite portion, and an upper ferrite portion. At least one pair of laterally spaced-apart interior conductors is disposed within the body generally between the upper and lower ferrite portions. The interior conductors longitudinally extend from about the first end to about the second end of the generally rectangular body. At least one first pair of end terminations is disposed on the first end of the generally rectangular body and is connected to the at least one pair of interior conductors. At least one second pair of end terminations is disposed on the second end of the generally rectangular body and is connected to the at least one pair of interior conductors. At least one nonmagnetic dielectric is disposed within the body and is disposed laterally between the at least one pair of interior conductors. The nonmagnetic dielectric is configured to control magnetic coupling between the at least one pair of interior conductors, whereby the current choke is operable with a coefficient of magnetic coupling between the at least one pair of interior conductors of less than about 0.90.

In another exemplary embodiment, a DC to DC converter comprises a current choke having a ferrite body, at least one pair of laterally spaced-apart interior conductors within the body, and a nonmagnetic dielectric within the body and generally between the at least one pair of interior conductors. The nonmagnetic dielectric is configured to control magnetic coupling between the at least one pair of interior conductors such that the current choke is operable with a coefficient of magnetic coupling between the at least one pair of interior conductors of about 0.70. The at least one pair of interior conductors is configured to provide the current choke with a current rating of about forty amperes.

Other aspects of the present disclosure relate to methods of configuring a device for use in a DC to DC converter. One exemplary embodiment includes a device having a ferrite body, at least one pair of laterally spaced-apart interior conductors within the body, and a nonmagnetic dielectric within the body and generally between the at least one pair of interior conductors. The method generally comprises magnetically decoupling the at least one pair of interior conductors by at least ten percent or more by selectively configuring the geometry of the nonmagnetic dielectric to control the extent of the magnetic coupling between the at least one pair of interior conductors.

In another exemplary embodiment, a method is provided for converting a direct current from a first voltage to a second voltage. The method generally comprises using a DC to DC converter having a current choke that includes a ferrite body, at least one pair of laterally spaced-apart interior conductors within the body, and a nonmagnetic dielectric within the body and generally between the at least one pair of interior conductors. The nonmagnetic dielectric is configured to control magnetic coupling between the at least one pair of interior conductors such that the current choke is operable with a coefficient of magnetic coupling between the at least one pair of interior conductors of less than about 0.90.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a current choke suitable for surface mounting to a circuit board for use in a DC to DC converter according to an exemplary embodiment;

FIG. 2 is a top view of the current choke as shown in FIG. 1;

FIG. 3 is a longitudinal top cross-sectional view of the current choke as shown in FIG. 1;

FIG. 4 is a front cross-sectional view of the current choke as shown in FIG. 1;

FIG. 5 is a side elevational view of the current choke as shown in FIG. 1;

FIG. 6 is a side cross-sectional view of the current choke as shown in FIG. 1;

FIG. 7A through 7D illustrate various exemplary connection configurations used for testing the current choke as shown in FIG. 1 in cross, common, differential, and open modes according to exemplary embodiments;

FIG. 8 illustrates the magnetic flux lines for the current choke as shown in FIG. 1 in the differential mode according to an exemplary embodiment; and

FIG. 9 illustrates the magnetic flux lines for the current choke as shown in FIG. 1 in the open mode according to an exemplary embodiment.

### DETAILED DESCRIPTION

The following description is merely exemplary in nature and is not intended to limit the present disclosure, application, or uses. It should be understood that throughout the drawings, corresponding reference numerals indicate like or corresponding parts and features.

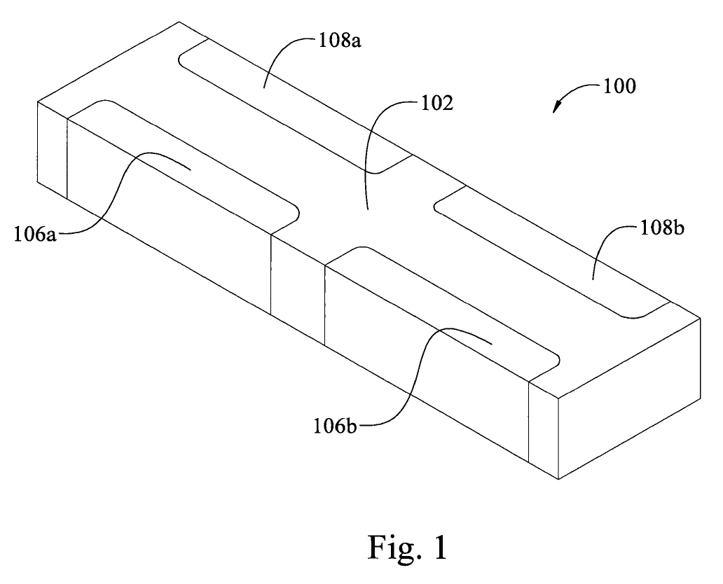

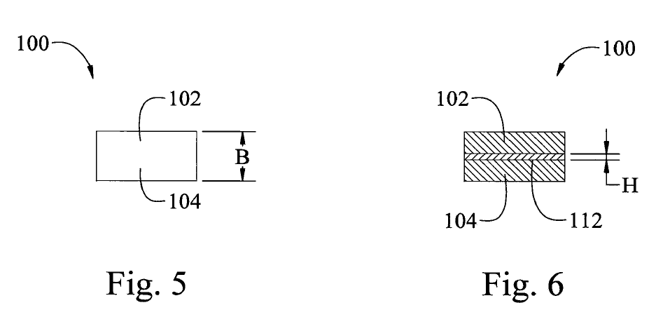

With reference now to the drawings, and particularly to FIGS. 1 through 6, an exemplary embodiment is shown of a current choke 100. By way of example, the current choke 100 may be surface mounted to a circuit board for use in a DC to DC converter.

As illustrated, the current choke 100 includes a plurality of joined together ferrite layers defining a generally rectangular body or slab. In this particular embodiment, the body comprises upper and lower layers of ferrite tape 102, 104. Alternatively, the body may be formed with additional layers of ferrite (e.g., an intermediate ferrite tape layer, etc.), from non-ferrite materials, and/or in other suitable shapes (e.g., non-rectangular shapes, etc.).

The exemplary current choke 100 also includes end terminations 106a, 106b and 108a, 108b and laterally spaced-apart, longitudinally-extending generally parallel interior conductors 110 and 112. The interior conductors 110 and 112 are within the body generally between the upper and lower ferrite tape layers 102, 104. The end terminations 106a, 106b are disposed on the first end of the generally rectangular ferrite body, and the other end terminations 108a, 108b are on the second end of the generally rectangular ferrite body. The end terminations 106a, 106b and 108a, 108b are respectively connected to opposite ends of the interior conductors 110, 112. The base material of the end terminations 106a, 106b, 108a, 108b may include, but are not limited to, silver, silver-palladium, silver-platinum, combinations thereof, etc., and may or may not be electroplated with a solderable finish, such as tin. For clarity of explanation, the conductors 110 and 112 are referred to herein as interior conductors to differentiate them from the end terminations 106a, 106b, 108a, 108b.

A nonmagnetic dielectric material 114 is disposed between the interior conductors 110 and 112. The nonmagnetic dielectric material 114 is configured so that the interior conductors 110, 112 are not electrically shorted to each other. The nonmagnetic dielectric 114 is also nonmagnetic so as to not provide magnetic material in the area between the conductors 110, 112. In the illustrated embodiment, the interior conductors 110, 112 extend in side-by-side relation along generally parallel linear paths along the lower ferrite layer 104 (between the lower ferrite layer and the upper ferrite layer 102) on opposite sides of the nonmagnetic dielectric 114.

In various embodiments, the ferrite material for the current choke 100 may be a standard ferrite material as provided, for example, in the form of a roll compacted tape. In one exemplary embodiment, the ferrite material may include a soft ferrite material. In other exemplary embodiments, the ferrite material may include a permeability of about two hundred up to frequencies of about ten megahertz. In one exemplary embodiment, the ferrite material may include a permeability of about two hundred at a frequency of about five megahertz. In other exemplary embodiments, a current choke body may include other magnetic materials, including soft magnetic materials such as, for example, iron powder, iron-based metal alloy powder, magnetic metal glass, etc. The dielectric material 114 may comprise titanium dioxide. The interior conductors 110 and 112 may comprise silver conductive ink. The end terminations 106a, 106b, 108a, 108b may be configured so as to provide solderable connections, for example, to conductive traces on a circuit board. By way of example, the interior conductors 110, 112 may be formed by screen printing a conductive paste or ink (e.g., silver ink, etc.). The end terminations 106a, 106b, 108a, 108b may comprise electrical contact pads formed from silver conductive ink, such as by dipping processes or printing techniques. The end terminations 106a, 106b, 108a, 108b may be electroplated with a barrier material, such as nickel, and a solderable layer, such as tin. In addition, the ferrite layers 102, 104 may be sintered to join the adjacent ferrite layers into a monolithic body. Accordingly, the current choke 100 may be referred to as a monolithic device that may be readily connected (e.g., surface mounted, etc.) to a circuit board, for example, by soldering the end terminations 106a, 106b, 108a, 108b to the circuit board.

Alternatively, other materials and manufacturing processes are possible for the body, ferrite layers, dielectric material (e.g., aluminum oxide, etc.), interior conductors (e.g., silver ink, ferrite-doped silver conductive ink, electrically conductive layers in stacked and joined together relation, etc.), and end terminations. By way of example, multiple print and dry cycles may be used to achieve a desired interior conductor thickness of about 0.15 millimeters (0.006 inches), for example. Alternately, a singled step of printing and drying may be used to form the desired conductor thickness.

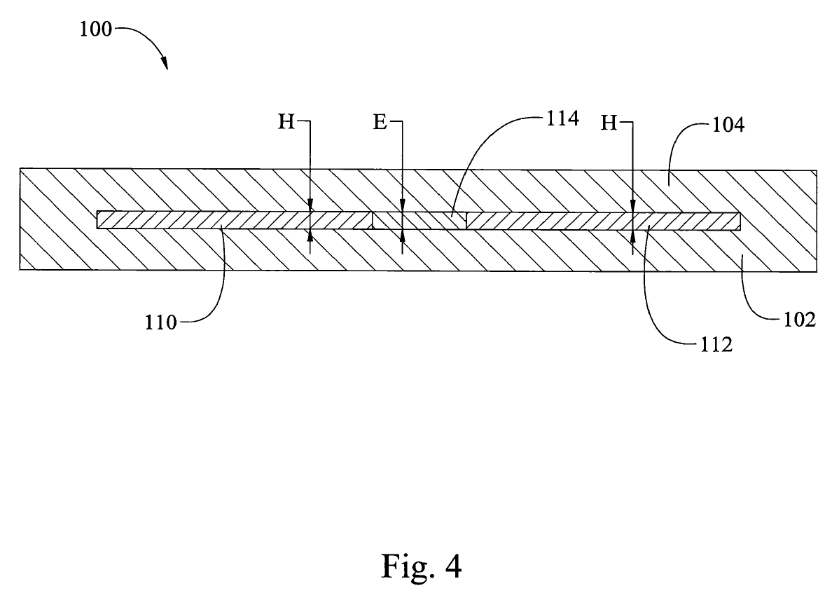

With further reference to FIG. 4, the interior conductors 110 and 112 and the nonmagnetic dielectric 114 have generally rectangular cross-sectional profiles and are shaped as right rectangular prisms. Alternatively, other shapes and cross-sectional shapes are possible in other embodiments. For example in some exemplary embodiments, nonmagnetic dielectrics may have geometries in which upper and lower surfaces are concave, convex, etc. in shape. In one exemplary embodiment, a dielectric may be generally elliptical in cross section. In addition in some exemplary embodiments, interior conductors may have geometries in which upper and lower surfaces are concave, convex, etc. in shape. In one exemplary embodiment, one or more interior conductor may be generally elliptical in cross section.

TABLE 1 below lists representative dimensions for the exemplary current choke 100. The dimensions provided in the table (as are all dimensions disclosed herein) are for purposes of illustration only and not for purposes of limitation, as other embodiments may have one or more components with different dimensions.

TABLE 1
EXEMPLARY DIMENSIONS

| DIMENSION | MILLIMETERS | INCHES |
|---|---|---|
| A (overall width) | 7.37 | 0.29 |
| B (overall height) | 1.00 | 0.039 |
| C (overall length) | 2.00 | 0.08 |
| D (dielectric width) | 0.86 | 0.034 |
| E (dielectric height) | 0.15 | 0.006 |
| F (dielectric length) | 2.00 | 0.08 |
| G (conductor width) | 2.54 | 0.100 |
| H (conductor height) | 0.15 | 0.006 |
| I (conductor length) | 2.00 | 0.08 |
| J (end termination width) | 3.30 | 0.13 |
| K (end termination length) | 0.51 | 0.02 |
| L (spaced distance) | 0.76 | 0.030 |
| M (spaced distance) | 0.98 | 0.04 |
| N (spaced distance) | 0.51 | 0.02 |
| R (radius) | 0.33 | 0.013 |

As noted in the above table for the exemplary current choke 100, each interior conductor 110, 112 has a lateral width G of about 0.100 inches (2.54 millimeters), a vertical height H of about 0.006 inches (0.15 millimeters), and a longitudinal length I of about 0.08 inches (2.00 millimeters). Accordingly, this embodiment includes conductors 110, 112 each having a cross-sectional area of about 763.84 circular mils. In one particular embodiment, each interior conductor 110, 112 is formed from silver ink with a resistivity of about 9.9 circular mil Ohms per foot and a calculated conductor resistance of about 0.00009 Ohms. Alternative embodiments may include interior conductors in different configurations (e.g., different shapes, sizes, resistivities, resistances, etc.).

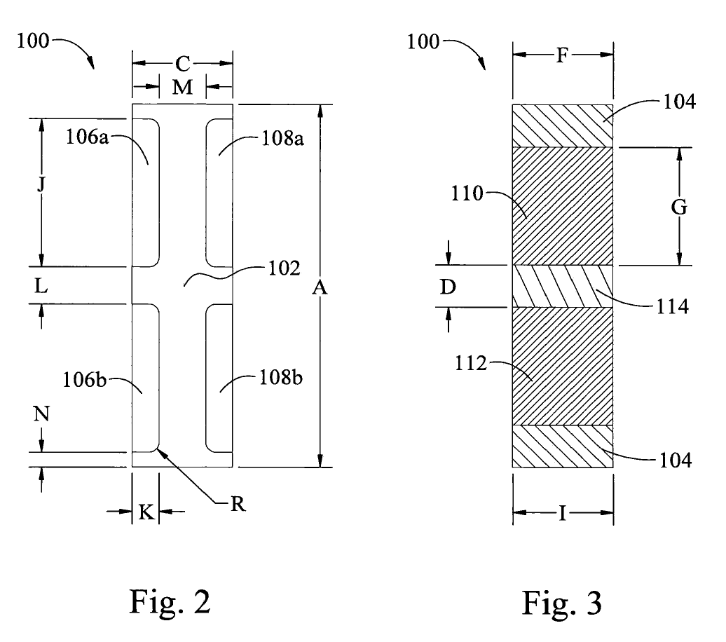

Continuing with this example, the nonmagnetic dielectric 114 is also shaped as a generally rectangular prism with a lateral width D of about 0.034 inches (0.86 millimeters), a vertical height E of about 0.006 inches (0.15 millimeters), and a longitudinal length F of about 0.08 inches (2.00 millimeters). With reference to FIG. 2, each end termination 106, 108 has a lateral width J of about 0.13 inches (3.30 millimeters) and a longitudinal length K of about 0.002 inches (0.51 millimeters). The spaced distance L is about 0.030 inches (0.76 millimeters) which separates the end termination 106a, 108a from the corresponding other end termination 106b, 108b in the lateral widthwise direction. The spaced distance M is about 0.04 inches (0.98 millimeters) in the lengthwise or longitudinal distance. In various embodiments, the end terminations 106a, 106b, 108a, 108b are provided or applied to the ferrite body by a dipping process, such that the thickness of the end terminations 106a, 106b, 108a, 108b is relatively small (and thus not illustrated in the cross-sectional views of FIGS. 3, 4, and 6) in comparison to the thickness of the other components, such as the ferrite layers, interior conductors, or dielectric. Overall, the current choke 100 is shaped as a generally rectangular prism with a lateral width A of about 0.29 inches (7.37 millimeters), a vertical height B of about 0.039 inches (1.00 millimeter), and a longitudinal length C of about 0.08 inches (2.00 millimeters).

Continuing with this particular example and its exemplary geometry, dimensions, parameters, etc., the current choke 100 had a current rating of about forty amperes and a calculated coefficient of magnetic coupling of about 0.70 (magnetic coupling factor of about 70%). Generally speaking, the amount of current supported by the current choke 100 depends, at least in part, on the configuration (e.g., size, material, shape, etc.) of the interior conductors 110, 112. Current chokes may support more than or less than about forty amperes of current within the scope of the present disclosure. The extent of the magnetic coupling (coefficient of magnetic coupling) between the interior conductors 110, 112 depends, at least in part, on the geometry (e.g., shape, size, etc.) of the nonmagnetic dielectric 114. Magnetic coupling generally refers to or relates to mutual inductance between the interior conductors 110, 112. Mutual inductance refers to the concept that the current flowing through one of the two conductors may induce a voltage in another nearby conductor. For example, the wider the nonmagnetic dielectric 114 between the interior conductors 110, 112 (and thus the further apart the interior conductors 110, 112 are laterally spaced from each other), the lower the magnetic coupling.

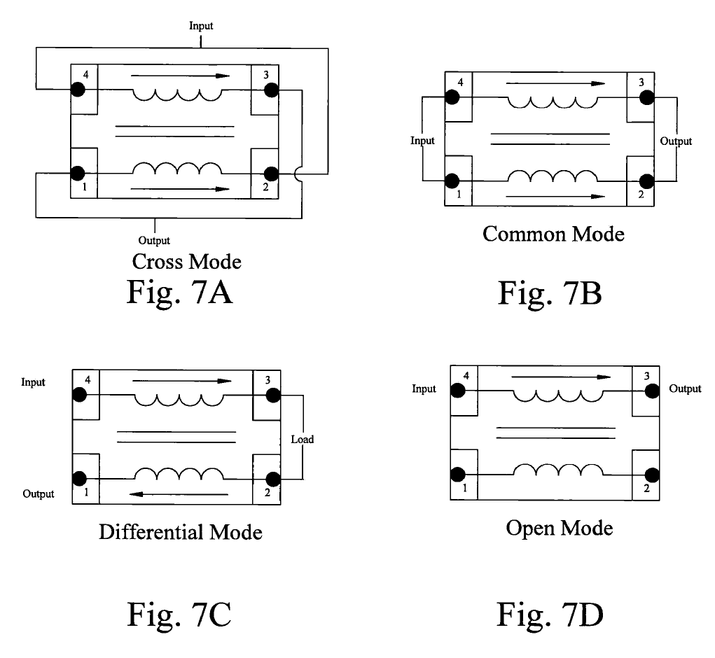

For this example, the following inductances were calculated for the current choke 100 for a signal frequency of about five megahertz. In the differential mode (FIG. 7C), the current choke 100 had a calculated inductance of about twelve nanohenries for signal frequencies of about five megahertz. In the cross mode (FIG. 7A), the current choke 100 had a calculated inductance of about six nanohenries for signal frequencies of about five megahertz. In the open mode (FIG. 7D), the current choke 100 had a calculated inductance of about twenty nanohenries for signal frequencies of about five megahertz. In the common mode (FIG. 7B), the current choke 100 had a calculated inductance of about seventeen and one-half nanohenries for signal frequencies of about five megahertz.

The height or thickness E (FIG. 4) of the nonmagnetic dielectric 114 may determine the maximum current allowable (e.g., about forty amperes in some embodiments, etc.) that will not otherwise saturate the core. The width D (FIG. 3) of the nonmagnetic dielectric 114 may determine the extent of magnetic coupling (e.g., magnetic coupling factor of about 70% in some embodiments, within a range of about 60% to about 90% in other embodiments, etc.). The amount of heat generated by the two conductors 110 and 112 during operation may be about 0.28 watts (i.e., about 0.14 watts each).

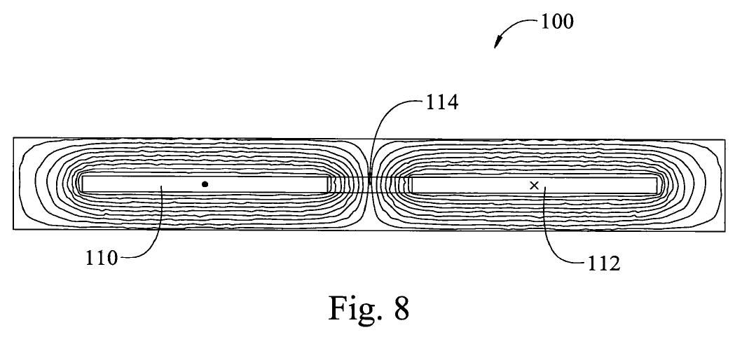

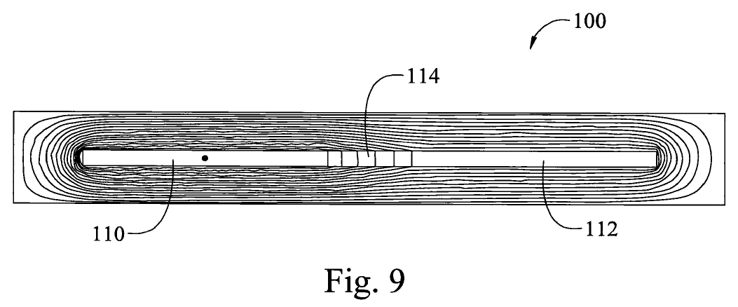

The performance of the exemplary current choke 100 is demonstrated in FIGS. 8 and 9. More particularly, FIG. 8 illustrates the magnetic flux lines for the current choke 100 in the differential mode (FIG. 7C). Current is shown moving into the page through interior conductor 110 (e.g., represented by a dot), and current is shown moving out of the page through interior conductor 112 (e.g., represented by an “x”). For this particular example with the current choke 100 in the differential mode, the flux/current (flux/current=inductance) was determined to be about 1.22938e-008−j 3.59335e-010 Henries. FIG. 9 illustrates the magnetic flux lines for the current choke 100 in the open mode (FIG. 7D). Current is shown moving into the page thorough interior conductor 110, and no current is shown moving through interior conductor 112. For this particular example with the current choke 100 in the open mode, the voltage drop across the interior conductor (the top conductor from input 4 to output 3 in FIG. 7D) was determined to be about 7.74879+j 52.111 Volts, while the voltage drop across the other interior conductor (the lower conductor between the open circuit from 1 to 2) was determined to be about −6.92806−j 36.6638 Volts. Accordingly, the magnetic coupling for the interior conductors in this example was about 0.70 (which may be calculated by dividing the imaginary part of the voltage drops 36.6638/52.111).

With common mode chokes, it is generally desirable to have very high magnetic coupling factors in the range of 97% to 99%. With such strong magnetic coupling, the common mode chokes are usually better at filtering unwanted signals. In contrast, some exemplary embodiments disclosed herein include current chokes that are configured so as to have much lower or weaker magnetic coupling than that which is typical for common mode chokes. For example, some exemplary embodiments include a current choke where the magnetic coupling factor is in the range of about 60% to about 90%. In one particular embodiment, a current choke is configured so as to have a magnetic coupling factor of about 70%. In various embodiments, the geometry of the nonmagnetic dielectric was specifically design and tailored so as to provide a magnetic coupling factor of about 70% while also allowing for sufficient room for the interior conductors to be configured to support about forty amperes of current. In contrast, traditional common mode chokes are typically designed with a different goal in mind, that is to obtain very high magnetic coupling close to 100%.

An exemplary manufacturing method will now be described for the current choke 100. In this example, the current choke 100 may be fabricated by first applying (e.g., depositing, pasting, etc.) a lower layer of ferrite material. Next, the interior conductors (e.g., silver ink, etc.) and nonmagnetic dielectric (e.g., titanium dioxide, etc.) are provided on the lower ferrite layer. For example, the nonmagnetic dielectric may be deposited on the lower ferrite layer with the conductors being screen printed over the lower ferrite layer, such that the conductors are laterally spaced apart with the nonmagnetic dielectric therebetween. An upper layer of ferrite material may then be applied (e.g., deposited, printed, etc.). The layers of ferrite with the conductors and dielectric in between may then be laminated together, then diced into individual pieces. The pieces will then be sintered to join the layers together into a monolithic body. The method may also include forming a first pair of end terminations on the first end of the body that are connected to the interior conductors, and forming a second pair of end terminations on the second end of the body that are also connected to the interior conductors. In one exemplary embodiment, the first and second end terminations are formed by dipping. The dipped terminations may also be electroplated with a solderable coating, such as tin.

In another exemplary embodiment, a method of making a current choke may generally include joining together a plurality of ferrite layers comprising at least an upper ferrite layer and a lower ferrite layer. In some embodiments, there may also be at least one or more intermediate ferrite layers between the upper and lower ferrite layers. Continuing with this example, an opening may be formed in the at least one intermediate ferrite layer that defines a cavity in the ferrite body. The cavity may extend from adjacent a first end of the body to adjacent a second end of the body. A pair of interior conductors may be formed on the at least one intermediate ferrite layer on opposite sides of the cavity. The method may also include forming a first pair of end terminations on the first end of the body that are connected to the interior conductors, and forming a second pair of end terminations on the second end of the body that are also connected to the interior conductors. In one exemplary embodiment, the process of forming the opening may include forming the opening to extend completely from the first end of the body to the second end of the body so that the cavity opens outwardly at the first and second ends of the body. In another embodiment, the cavity may have closed ends such that the cavity is contained entirely within the body. The cavity may be filled with air, or may be at least partially or completely filled with a body of non-magnetic dielectric material.

Other fabrication methods are also contemplated and may be used in other embodiments. In addition, other embodiments may include more than two layers of ferrite material being used, for example, for forming the generally rectangular ferrite body. By way of example only, an alternative current choke embodiment includes four ferrite layers that form the generally rectangular ferrite body. In this alternative embodiment, each of the upper and lower ferrite portions includes two ferrite layers. In still other exemplary embodiments, air may be used as a dielectric material (e.g., an air gap may be formed in the ferrite material).

In the illustrated embodiments, single top and bottom ferrite layers have been described. In alternative embodiments, either or both of the top and bottom ferrite layers may be formed by several layers sintered together. In addition, although current chokes have been disclosed herein in terms of layers, the layers are typically not discrete after sintering as the adjacent layers tend to fuse or join together. In addition, other embodiments may also include more than one pair of internal conductors and their associated cavity and/or nonmagnetic dielectric. In addition, other embodiments of a current choke may include a cavity filled with air that has a single end or both ends closed and/or a single end or both ends open.

The term “current choke” is used herein for purposes of description only and is not intended to limit the scope of the present disclosure. For example, the current choke could be used as a common mode choke, a differential mode choke, etc.

Certain terminology is used herein for purposes of reference only, and thus is not intended to be limiting. For example, terms such as “upper”, “lower”, “above”, “below”, “top”, “bottom”, “upward”, and “downward” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features and the exemplary embodiments, the articles “a”, “an”, “the” and “the” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A current choke suitable for surface mounting to a circuit board for use in a DC to DC converter, the current choke comprising a generally rectangular body having opposing first and second ends, and including:
a lower ferrite portion;
an upper ferrite portion;
at least one pair of laterally spaced-apart interior conductors within the body generally between the upper and lower ferrite portions and longitudinally extending from about the first end to about the second end of the generally rectangular body;
at least one first pair of end terminations on the first end of the generally rectangular body and connected to the at least one pair of interior conductors;
at least one second pair of end terminations on the second end of the generally rectangular body and connected to the at least one pair of interior conductors;
at least one nonmagnetic dielectric within the body and disposed laterally between the at least one pair of interior conductors, the nonmagnetic dielectric configured to control magnetic coupling between the at least one pair of interior conductors, whereby the current choke is operable with a coefficient of magnetic coupling between the at least one pair of interior conductors of less than about 0.90.

2. The current choke of claim 1, wherein the nonmagnetic dielectric is configured so as to control the magnetic coupling such that the current choke is operable with a coefficient of magnetic coupling between the at least one pair of interior conductors within a range of about 0.60 to about 0.90.

3. The current choke of claim 2, wherein the dielectric is configured to control the magnetic coupling between the at least one pair of interior conductors so that the coefficient of magnetic coupling is about 0.70.

4. The current choke of claim 3, wherein the nonmagnetic dielectric has a generally rectangular prism shape with a lateral width of about 0.86 millimeters.

5. The current choke of claim 4, wherein the nonmagnetic dielectric has a vertical height of about 0.15 millimeters and a longitudinal length of about 2.00 millimeters.

6. The current choke of claim 3, wherein the at least one pair of interior conductors are configured to provide the current choke with a current rating of about forty amperes.

7. The current choke of claim 6, wherein each interior conductor of the at least one pair of interior conductors has a generally rectangular prism shape with a lateral width of about 2.54 millimeters, a vertical height of about 0.15 millimeters, and a longitudinal length of about 2.00 millimeters.

8. The current choke of claim 1, wherein each of the at least one pair of interior conductors is formed from silver ink, and wherein the nonmagnetic dielectric is formed from titanium dioxide.

9. The current choke of claim 1, wherein the current choke has a low profile with an overall height less than about 1 millimeter or less.

10. The current choke of claim 1, wherein each of the at least one pair of interior conductors has a strip shape.

11. The current choke of claim 1, wherein the dielectric is generally rectangular in cross-section with a width of about 0.86 millimeters.

12. The current choke of claim 1, wherein the current choke is surface mounted to a circuit board.

13. The current choke of claim 1, wherein the ferrite portions have a permeability of about two hundred at frequencies up to about ten megahertz.

14. A DC to DC converter comprising the current choke of claim 1.

15. A DC to DC converter comprising a current choke having a ferrite body, at least one pair of laterally spaced-apart interior conductors within the body, and a nonmagnetic dielectric within the body and generally between the at least one pair of interior conductors, the nonmagnetic dielectric configured to control magnetic coupling between the at least one pair of interior conductors such that the current choke is operable with a coefficient of magnetic coupling between the at least one pair of interior conductors of about 0.70, the at least one pair of interior conductors configured to provide the current choke with a current rating of about forty amperes.

16. The DC to DC converter of claim 15, wherein the nonmagnetic dielectric has a generally rectangular prism shape with a lateral width of about 0.86 millimeters.

17. The DC to DC converter of claim 16, wherein the nonmagnetic dielectric has a vertical height of about 0.15 millimeters and a longitudinal length of about 2.00 millimeters.

18. The DC to DC converter of claim 15, wherein each interior conductor of the at least one pair of interior conductors has a generally rectangular prism shape with a lateral width of about 2.54 millimeters, a vertical height of about 0.15 millimeters, and a longitudinal length of about 2.00 millimeters.

19. A method of configuring a device for use in a DC to DC converter, the device including a ferrite body, at least one pair of laterally spaced-apart interior conductors within the body, and a nonmagnetic dielectric within the body and generally between the at least one pair of interior conductors, the method comprising:
magnetically decoupling the at least one pair of interior conductors by at least ten percent or more by selectively configuring the geometry of the nonmagnetic dielectric to control the extent of the magnetic coupling between the at least one pair of interior conductors.

20. The method of claim 19, further comprising providing at least one first pair of end terminations on the first end of the ferrite body and connected to the at least one pair of interior conductors, and providing at least one second pair of end terminations on the second end of the ferrite body and connected to the at least one pair of interior conductors.

21. The method of claim 19, wherein the geometry of the nonmagnetic dielectric is selectively configured such that the device is operable with a magnetic coupling factor between the at least one pair of interior conductors within a range of about sixty percent to about ninety percent.

22. The method of claim 19, wherein the geometry of the nonmagnetic dielectric is selectively configured such that the device is operable with a magnetic coupling factor of about seventy percent between the at least one pair of interior conductors.

23. The method of claim 19, wherein the geometry of the nonmagnetic dielectric is selectively configured such that the nonmagnetic dielectric has a generally rectangular prism shape with a lateral width of about 0.86 millimeters.

24. The method of claim 23, wherein the geometry of the nonmagnetic dielectric is selectively configured such that the nonmagnetic dielectric has a vertical height of about 0.15 millimeters and a longitudinal length of about 2.00 millimeters.

25. The method of claim 19, further comprising selectively configuring the at least one pair of interior conductors to provide the device with a current rating of about forty amperes.

26. The method of claim 25, wherein each interior conductor of the at least one pair of interior conductors is selectively configured to have a generally rectangular prism shape with a lateral width of about 2.54 millimeters, a vertical height of about 0.15 millimeters, and a longitudinal length of about 2.00 millimeters.

27. The method of claim 19, further comprising surface mounting the device to a circuit board.

28. A method of converting a direct current from a first voltage to a second voltage, the method comprising using a DC to DC converter having a current choke that includes a ferrite body, at least one pair of laterally spaced-apart interior conductors within the body, and a nonmagnetic dielectric within the body and generally between the at least one pair of interior conductors, the nonmagnetic dielectric configured to control magnetic coupling between the at least one pair of interior conductors such that the current choke is operable with a coefficient of magnetic coupling between the at least one pair of interior conductors of less than about 0.90.
